(19) United States
(12) Patent Application Publication
(10) Pub. No.: US 2008/0281602 A1
(43) Pub. Date: Nov. 13, 2008

(54) Coding Reverberant Sound Signals

(75) Inventors: Nicolle Hanneke Van Schijndel, Eindhoven (NL); Andreas Johannes Gerrits, Eindhoven (NL); Corrado Boscarino, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/569,778

(22) PCT Filed: Jun. 3, 2005
(86) PCT No.: PCT/IB2005/051820

§ 371 Date: Nov. 29, 2006

(30) Foreign Application Priority Data
Jun. 8, 2004 (EP) 04102582.6

(51) Int. Cl. G10L 19/00

(52) U.S. Cl. 704/500; 704/E19.001

(57) ABSTRACT

The invention relates to an audio encoder and decoder and methods for audio encoding and decoding. In the encoder an audio signal is split into an anechoic signal part and information regarding a reverberant field associated with the audio signal, preferably by a representation using only few parameters such as reverberation time and reverberation amplitude. The anechoic signal is then encoded using an audio codec. At the decoder the anechoic signal part is restored using the audio codec, and the restored anechoic signal part is transformed into the substantially original audio signal by applying reverberance according to the information regarding the reverberant field, preferably by convolution with a room impulse response generated on the basis of the reverberant field information. According to the invention the audio codec involved needs only be capable of encoding anechoic audio signals, thus solving the problem of parametric audio codecs providing poor performance on reverberant audio signals.

The invention relates to the field of audio signal coding. Especially, the invention relates to the field of efficient coding of reverberant audio signals. The invention relates to an encoder, a decoder, methods for encoding and decoding, an encoded audio signal, storage and transmission media with data representing such encoded signal, and audio devices with an encoder and/or decoder.

Reverberation is caused by the acoustics of the environment, e.g. a concert hall, in which the sound is recorded. It consists of the reflections against surfaces in this environment. As a result, the recorded sound signal does not only contain the direct “dry” audio signal, but also a series of delayed and attenuated reflections. I.e. the reverberation component consists of delayed and attenuated versions of the direct “dry” sound and, as a result, the reverberant component is correlated with the direct signal. Here, “dry” means “anechoic”, i.e. containing substantially no echoes or reverberation.

Experiments show that some non-transparent sound codecs do not function properly by coding sound signals with a significant amount of reverberation, i.e. the codecs produce sound signals with clearly audible artefacts. However, the same sound codec may perform well on sound signals with very or purely “dry” signals, i.e. sound signals recorded in an anechoic environment or artificially created sounds without reverberation added.

In many applications, reverberation is considered a negative characteristic of the sound signal. For example, the performance of automatic speech recognition systems degrades when the speech contains reverberation, and, in communication applications, reverberation negatively affects the intelligibility and quality of the speech. A solution to this problem may be to remove the reverberation from the signal, i.e., to de-reverberate, and this is also done in some systems (Basbug et al., 2003)—see the list of references.

In high-quality audio coding, however, the situation is different. Audio coding strives for transparency, and therefore the reverberation needs to be coded as well. Moreover, in music the reverberation component is an important part of the signal and audio signals with this component are preferred to signals without it, which sound “dry” or dull, and the sound lacks the significant individual character of the recording environment.

To the knowledge of the inventors in the prior art no special precautions are taken to code the reverberation component of sound signals and this may lead to quality problems.

It may be seen as an object of the present invention to provide a method and an audio encoder and decoder capable of handling reverberant audio signals in high quality by using audio codecs.

According to a first aspect of the invention, this object is complied with by providing an audio encoder adapted to encode an audio signal, the audio encoder comprising

separation means adapted to separate the audio signal into a substantially anechoic audio signal and information describing a reverberant field associated with the audio signal,

encoder means adapted to encode the substantially anechoic audio signal into a first encoded signal part and encode the information describing the reverberant field into a second encoded signal part.

The separation means serves to split the audio signal into an anechoic, i.e. “dry”, part and into information regarding reverberant aspects related to the audio signal. In other words, the audio signal is de-reverberated, and information describing a reverberant field associated with the audio signal is extracted, i.e. information enabling a substantially transparent recreation of the reverberance.

The encoder means handles the “dry” part and the reverberant part separately. Thus, it is possible to apply an audio codec for encoding the “dry” part to the first encoded signal part, while the reverberation part may be encoded according to completely different algorithms suited to describe reverberation, such as a parametric description sufficiently precise to substantially recreate the reverberation part of the signal at the encoder.

This relieves the audio codec from the task of coding the reverberation component, solving the problem of coding reverberant sound signals. Instead, means for encoding a reverberant part of the reverberant audio signal may comprise reverberation algorithms based on a parametric description of the reverberant part of the original audio signal such using a very limited number of parameters. As an effect, a parametric codec may be used solely for encoding a “dry” signal, which such codec is well suited for. Hereby it is possible to substantially transparently encode and decode a reverberant audio signal using an audio codec in combination with means for encoding a reverberant part of the reverberant audio signal.

In addition, encoding efficiency is increased compared to encoding a reverberant sound signal directly. This is due to the fact that an encoder according to the first aspect exploits the correlation introduced in the sound signal by the reverberant field to the maximum, resulting in higher coding efficiency. I.e. redundancy in the reverberant part is taken into account specifically.

In one embodiment the encoder means may be adapted to encode the substantially anechoic audio signal according to a parametric audio codec. e.g. (Schuijers et al., 2003). In another preferred embodiment, the separation means is adapted to apply Unoki's de-reverberation algorithm to the audio signal so as to separate it into the substantially anechoic part and the information describing the reverberant field. By Unoki's de-reverberation algorithm is understood the de-reverberation principles described in: M. Unoki, M. Furukawa, K. Sakata, and M. Akagi, “A Method based on the MTF Concept for dereverberating the Power Envelope from the Reverberant Signal,” in Proc. IEEE Int. Conf. on Acoust, Speech, Signal Processing, Hong Kong, China, Apr. 6-19, Vol. I, pp. 840-843, 2003. This paper is hereby incorporated by reference.

A second aspect of the invention provides an audio decoder adapted to regenerate an audio signal from an encoded audio signal with first and second parts, the audio decoder comprising

decoder means adapted to decode the first encoded signal part into a substantially anechoic audio signal, the decoder means further being adapted to generate from the second encoded signal part information describing a reverberant field associated with the audio signal, and

transforming means adapted to add reverberance to the substantially anechoic audio signal based on the information describing the reverberant field.

Thus, the audio decoder according to the second aspect is adapted to decode an encoded signal from the audio encoder according to the first aspect and thus form an encoder/decoder system.

In the decoder means the “dry” signal is reconstructed. Reverberance is then added to the “dry” signal by the transforming means based on the reverberation information. This is known from existing artificial reverberation generators or room simulators that are able to produce high audio quality reverberation based on few parameters. An extra advantage of this method, i.e., addition of reverberation in the decoder, is that the reverberance masks some potential artefacts in the decoded “dry” signal.

Preferably, the transforming means comprises means for convoluting the regenerated anechoic audio signal with an impulse response h(t) being a function of time t, wherein h(t) is based on the second encoded signal part.

Preferably, the second encoded signal part comprises a representation of
a first parameter T related to a reverberation time of the audio signal, and

a second parameter A related to a reverberation amplitude of the audio signal.

The decoder means may be adapted to decode the first encoded signal part according to a parametric audio codec.

In a third aspect the invention provides a method of encoding an audio signal, comprising the steps of

separating the audio signal into a substantially anechoic part and information describing a reverberant field associated with the audio signal,

encoding the substantially anechoic part of the audio signal into a first encoded signal,

encoding the information describing the reverberant field into a second encoded signal.

In a fourth aspect the invention provides a method of decoding an encoded audio signal representing an original audio signal, the method comprising the steps of

decoding a first encoded signal part into a first audio signal,

decoding a second encoded signal part into information describing a reverberant field associated with the original audio signal and

transforming the first audio signal by adding reverberation based on the information describing the reverberant field so as to regenerate the original audio signal.

In a fifth aspect the invention provides an encoded audio signal representing an original audio signal, the encoded signal comprising

a first part representing a substantially anechoic part of the original audio signal, and

a second part representing information about a reverberant field associated with the original audio signal.

The encoded signal may be a digital electrical signal with a format according to standard digital audio formats. The signal may be transmitted using an electrical connecting cable between two audio devices. However, the encoded signal could be a wireless signal, such as an air-borne signal using a radio frequency carrier, or it may be an optical signal adapted for transmission using an optical fiber.

In a sixth aspect the invention provides a storage medium comprising data representing an encoded audio signal according to the fifth aspect. The storage medium is preferably a standard audio data storage medium such as DVD, CD, read-writable CD, minidisk, MP3 disc, compact flash, memory stick etc. However, it may also be a computer data storage medium such as a computer hard disk, a computer memory, a floppy disk etc.

In a seventh aspect the invention provides an audio device comprising an audio encoder according to the first aspect.

In an eighth aspect the invention provides an audio device comprising an audio decoder according to the second aspect.

Preferred audio devices according to the seventh and eighth aspects are all different types of tape, disk, or memory based audio recorders and players. For example: MP3 players, DVD players, audio processors for computers etc. In addition, it may be advantageous for mobile phones.

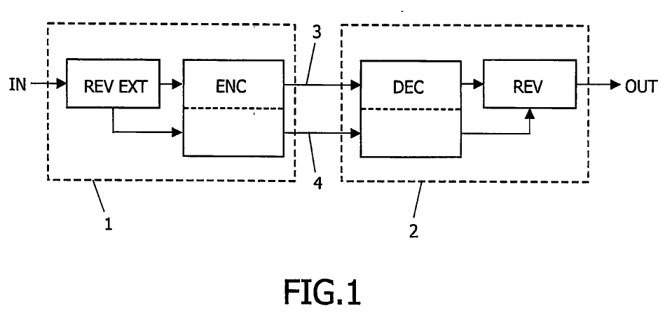

In the following the invention is described in more details with reference to the accompanying FIG. 1 illustrating a block diagram of a preferred encoder and decoder according to the invention.

While the invention is susceptible to various modifications and alternative forms, specific embodiments have been shown by way of example in the drawing and will be described in detail herein. It should be understood, however, that the invention is not intended to be limited to the particular forms disclosed. Rather, the invention is to cover all modifications, equivalents, and alternatives falling within the spirit and scope of the invention as defined by the appended claims.

FIG. 1 shows a block diagram illustrating the principles of a preferred embodiment of an encoder 1 and decoder 2 with respect to signal flow.

An audio signal is received at an input IN of the encoder 1. First, the audio signal is handled by a reverberation extractor REV EXT. Here, the audio signal is de-reverberated using Unoki's de-reverberation algorithm (Unoki et al., 2003). It should be noted that for monaural signals, it is not trivial to extract the reverberation component from a reverberant audio signal. However, this extraction does not have to be perfect and a gain may already be obtained by removing part of the reverberant field. For multi-channel signals already good de-reverberation algorithms exist.

The resulting “dry” signal is then encoded in an SSC encoder part of the encoder means ENC such as described in (Schuijers et al., 2003), while another part of the encoder means ENC encodes the reverberant part extracted by the reverberation extractor REV EXT. Output from the encoder 1 has two parts: a first part being a bit stream 3 provided by the SSC encoder part of the encoder means ENC, and a second part comprising two reverberation parameters 4 provided by the reverberation extractor REV EXT, i.e. a parameter description of the removed reverberation part of the original audio signal. Preferably, the two reverberation parameters 4 are the reverberation time T_{R}, and a reverberation amplitude constant A, associated with a level of the reverberation part of the original audio signal relative to the “dry” part of the audio signal, being a very brief description of the room reverberation impulse response h(t). One could also send the complete room reverberation impulse response h(t) in the beginning of the signal, with updates during the signal when needed; this is also efficient, because h(t) usually varies slowly or not at all. The encoder part of the encoder means ENC that encodes the reverberant part highly depends on the actual form of the reverberant part delivered by the reverberation extractor REV EXT. In case the reverberation extractor REV EXT delivers only a few reverberation parameters, encoding of the reverberation part can be said to be included in the extraction itself, and thus the encoder means ENC may not need to add further encoding to the reverberation part received from the reverberation extractor REV EXT.

The decoder 2 receives the SSC encoded signal 3 and the two reverberation parameters 4 from the encoder 1. It is to be understood that the FIG. 1 merely illustrates the principles of an encoder/decoder system. The encoded signals 3, 4, or data representing these signals 3, 4, may typically be stored on a data carrier or storage medium, such as an audio disk for a MP3 player etc.

In the decoder 2 the SSC encoded signal 3 is decoded by a SSC decoder part of the decoder means DEC thus restoring the substantially “dry” audio signal. This restored “dry” signal is then fed to a reverberation processor REV. The reverberation processor REV also receives the two reverberation parameters 4 that have been decoded by another part of the decoder means DEC, and based on these parameters 4, the reverberation processor REV generates an impulse response based on the extracted reverberation information in the two reverberation parameters 4, i.e. a room impulse response is constructed based on the two reverberation parameters 4. The reverberation part of the original audio signal is applied to the restored “dry” audio signal from the SSC decoder part of the decoder means DEC by convolution with the generated reverberation impulse response. The restored “dry” audio signal is thus transformed into a restored, or at least substantially restored, original audio signal. Finally, this restored original audio signal is the provided at an output OUT of the encoder 2.

The room reverberation impulse response h(t), where t denotes time, generated in the reverberation processor REV is preferable of the form:

h(t)=A*exp(−6.9 t/TR)*n(t),

in which n(t) is a white noise signal.

In principle the invention can be used in connection with any audio encoder, e.g. the SSC encoder as mentioned described in (Schuijers et al., 2003), which is currently being standardised in MPEG, and with any, de-reverberation algorithm.

Encoders and decoders according to the invention may be implemented on a single chip with a digital signal processor. The chip can then be applied built into audio devices independent on signal processor capacities of such devices. The encoders and decoders may alternatively be implemented purely by algorithms running on a main signal processor of the application device.

In the claims reference signs to the figures are included for clarity reasons only. These references to exemplary embodiments in the figures should not in any way be construed as limiting the scope of the claims.

### LIST OF REFERENCES

F. Basbug, K. Swaminathan, and S. Nandkumar, “Noise Reduction and Echo Cancellation Front-End for Speech Codecs,” IEEE Transactions on Speech and Audio Processing, vol. 11, no. 1, 2003.
E. Schuijers, W. Oomen, B. den Brinker, J. Breebaart, “Advances in Parametric Coding for High-Quality Audio,” in Proc. of the 114th AES Convention 2003 March 22-25 Amsterdam, The Netherlands, 2003.
M. Unoki, M. Furukawa, K. Sakata, and M. Akagi, “A Method based on the MTF Concept for dereverberating the Power Envelope from the Reverberant Signal,” in Proc. IEEE Int. Conf. on Acoust., Speech, Signal Processing, Hong Kong, China, April 6-19, Vol. I, pp. 840-843, 2003.

1. An audio encoder (1) adapted to encode an audio signal, the audio encoder (1) comprising:
separation means adapted to separate the audio signal into a substantially anechoic audio signal and information describing a reverberant field associated with the audio signal,
encoder means adapted to encode the substantially anechoic audio signal into a first encoded signal part (3) and encode the information describing the reverberant field into a second encoded signal part (4).

2. Audio encoder (1) according to claim 1, wherein the separation means is adapted to apply Unoki's de-reverberation algorithm to the audio signal so as to separate it into the substantially anechoic part and the information describing the reverberant field.

3. Audio encoder (1) according to claim 1, wherein the encoder means is adapted to encode the substantially anechoic audio signal according to a parametric audio codec.

4. An audio decoder (2) adapted to regenerate an audio signal from an encoded audio signal with first (3) and second (4) parts, the audio decoder (2) comprising
decoder means adapted to decode the first encoded signal part (3) into a substantially anechoic audio signal, the decoder means further being adapted to generate from the second encoded signal part (4) information describing a reverberant field associated with the audio signal, and
transforming means adapted to add reverberance to the substantially anechoic audio signal based on the information describing the reverberant field.

5. Audio decoder (2) according to claim 4, wherein the transforming means comprises means for convoluting the substantially anechoic audio signal with an impulse response h(t) being a function of time t, wherein h(t) is based on the information describing the reverberant field.

6. Audio decoder (2) according to claim 5, wherein the decoder means is adapted to generate from the second encoded signal part (4)
a first parameter T related to a reverberation time of the audio signal, and
a second parameter A related to a reverberation amplitude of the audio signal.

7. Audio decoder (2) according to claim 6, wherein the transforming means is adapted to calculate said impulse response h(t) based on said first and second parameters as h(t)=A*exp(k*t/T)*n(t), wherein k represents a constant and n(t) represents a noise signal.

8. Audio decoder (2) according to claim 4, wherein the decoder means is adapted to decode the first encoded signal part (3) according to a parametric audio codec.

9. A method of encoding an audio signal, comprising the steps of
separating the audio signal into a substantially anechoic part and information describing a reverberant field associated with the audio signal,
encoding the substantially anechoic part of the audio signal into a first encoded signal,
encoding the information describing the reverberant field into a second encoded signal.

10. A method of decoding an encoded audio signal representing an original audio signal, the method comprising the steps of
decoding a first encoded signal part into a first audio signal,
decoding a second encoded signal part into information describing a reverberant field associated with the original audio signal, and
transforming the first audio signal by adding reverberation based on the information describing the reverberant field so as to regenerate the original audio signal.

11. Encoded audio signal (3), (4) representing an original audio signal, the encoded signal (3), (4) comprising
a first part (3) representing a substantially anechoic part of the original audio signal, and
a second part (4) representing information about a reverberant field associated with the original audio signal.

12. A storage medium comprising data representing an encoded audio signal (3), (4) according to claim 11.

13. Audio device comprising an audio encoder (1) according to claim 1.

14. Audio device comprising an audio decoder (2) according to claim 4.
